(19) United States
(12) Patent Application Publication
(10) Pub. No.: US 2013/0023233 A1
(43) Pub. Date: Jan. 24, 2013

(54) Shared Location

(71) Applicant: Lynne Seitz, Seattle, WA (US)

(72) Inventor: Lynne Seitz, Seattle, WA (US)

(21) Appl. No.: 13/552,110

(22) Filed: Jul. 18, 2012

Related U.S. Application Data
(60) Provisional application No. 61/457,953, filed on Jul. 18, 2011.

(51) Int. Cl. H04W 4/02; H04W 4/24; H04W 12/02

(52) U.S. Cl. 455/406; 455/411

(57) ABSTRACT

A mobile device including a location sharing application that enables the wireless device to be ‘opted-in’ to disclosing its current location when manually triggered to ‘sell’ that current location. When opting-in, the mobile device with location sharing application may include or be associated with relevant pre-registered or pre-stored profile data provided with that current location opt-in. The ‘opt-in’ nature of the present invention provides a win-win situation for both marketers and wireless device users by ensuring privacy is disclosed only if, when and where the wireless device with location sharing application initiates such disclosure.

The present invention claims priority from U.S. Provisional No. 61/457,953 filed Jul. 18, 2011, entitled “Shared Location”, to Fleck-Seitz, the entirety of which is expressly incorporated herein by reference.

### BACKGROUND OF THE INVENTION

1. Field of the Invention

This invention relates generally to telecommunications. More particularly, it relates to location based applications in wireless devices.

2. Background of the Related Art

Location-based advertising (LBA) is a new form of advertising that integrates mobile advertising with different mobile technologies. Research reports have predicted strong growth of the global location-based services market, and predict the market will only get bigger in the near future. Unlike other traditional media, location-based advertising is not only used principally for advertising, but also doubles as a means of researching consumers. Known or unknown to them, consumers are constantly providing information on their behavior through mobile internet activity.

Location-based advertising permits the ability to target advertising and other marketing activities toward specific consumers likely to use given goods or services. However, that said, targeted mobile marketing requires customization of advertising content to reach interested and relevant customers. To customize such behavioral personal data, user profiling, data mining and other behavior watch tools are conventionally employed, but privacy advocates warn that this may cause privacy concerns.

### SUMMARY OF THE INVENTION

In accordance with the principles of the present invention, a method of tracking location of a wireless device comprises registering a wireless device including a location sharing application. A user-triggered report of current location is received. The user-triggered report of current location is accepted by verifying that the relevant location sharing wireless device has moved. The location sharing wireless device is credited with value, whereby privacy is ensured by enabling disclosure of current location only if, when and where the location sharing wireless device initiates such disclosure.

A method of providing location of a wireless device in accordance with another aspect of the invention comprises executing a location sharing application on a wireless device. A first report of a first current location of the location sharing wireless device is manually triggered to a network server. The location of the wireless device is changed. A second report of a second current location of the location sharing wireless device is manually triggered to the network server. A value credit is received upon verification that the first current location is significantly different from the second current location. Whereby privacy is ensured by enabling disclosure of current location only if, when and where the location sharing wireless device initiates such disclosure.

### BRIEF DESCRIPTION OF THE DRAWINGS

Features and advantages of the present invention will become apparent to those skilled in the art from the following description with reference to the drawings, in which:

FIG. 1 shows an exemplary method of location sharing, in accordance with the principles of the present invention.

FIG. 2 shows an exemplary embodiment of a location sharing application operable on a wireless device earning income for a provider of the services, in accordance with the principles of the present invention.

FIG. 3 shows an exemplary embodiment of a carrier channel, in accordance with the principles of the present invention.

### DETAILED DESCRIPTION OF ILLUSTRATIVE EMBODIMENTS

The inventor has appreciated that an important growth feature for Location Based Advertising is the ability to collect consumer analytics that can enable customized mobile marketing while addressing consumer privacy concerns. The present invention provides a mobile device including a location sharing application that enables the wireless device to be ‘opted-in’ to disclosing its current location when manually enabled to ‘sell’ its current location. When opting-in, the mobile device with location sharing application may include or be associated with relevant pre-registered or pre-stored profile data. Such current location information together with relevant profile data is valuable information to mobile marketers, and the ‘opt-in’ nature of the present invention provides a win-win situation for both marketers and wireless device users by ensuring privacy is disclosed only if, when and where the wireless device with location sharing application initiates such disclosure.

Preferably the location sharing application is downloaded to the relevant wireless device as a downloaded application. Alternatively, the location sharing application may be pre-loaded onto the relevant wireless device, or distributed through any suitable channel (or channels), e.g., via a carrier website, or a retail store such as the Apple™ store, Android™ marketplace, etc.

Preferably most if not all privacy issues are addressed by the use of a highly transparent and voluntary instruction to share a given current location by the wireless device if, when and where the wireless device with location sharing application instructs such sharing. In this way, even a wireless device with full capability and preregistration to share current location information shares current location information only if, when and where such sharing is instructed by concurrent user initiation.

The sharing of current location information may be made transparent by rewarding location sharing wireless device accounts with a suitable desirable reward. Thus, the relevant mobile device including the location sharing application (i.e., the “location sharing application device”) is rewarded for initiating a sharing of a given current location under the control of the location sharing application thereon.

In accordance with the principles of the present invention, all location and movement of a wireless device is not necessarily disclosed, but rather only the current locations, and only when, the location sharing wireless device initiates a sharing of that particular current location only.

While in disclosed embodiments the location sharing wireless device shares its current location in real time if, when and where the wireless device initiates such sharing of a particular location, the present invention also envisions storage and later transmission of disclosed current locations measured at multiple locations over a period of time. Nevertheless, in accordance with the invention, each shared location must be ‘opted-in’ by the location sharing wireless device most preferably when the location sharing wireless device was located at each shared location.

The opt-in shared current location information is preferably captured by a suitable mobile marketing server and stored in a suitable database for immediate or near-term use by an interested marketer, or the scenario where all information is collector/stored and then shared with marketers either en-masse (historical info) or in real-time.

In accordance with the principles of the invention, bonus opportunities can be provided to a given wireless device or account associated with a given location sharing wireless device, which may then earn more rewards in exchange for providing additional marketing data.

Preferably, the user of the location sharing wireless device may request a ‘cash-out’ of their account credits, bonus, or other remuneration earned with opt-in activity through a given period (e.g., monthly, quarterly, etc.)

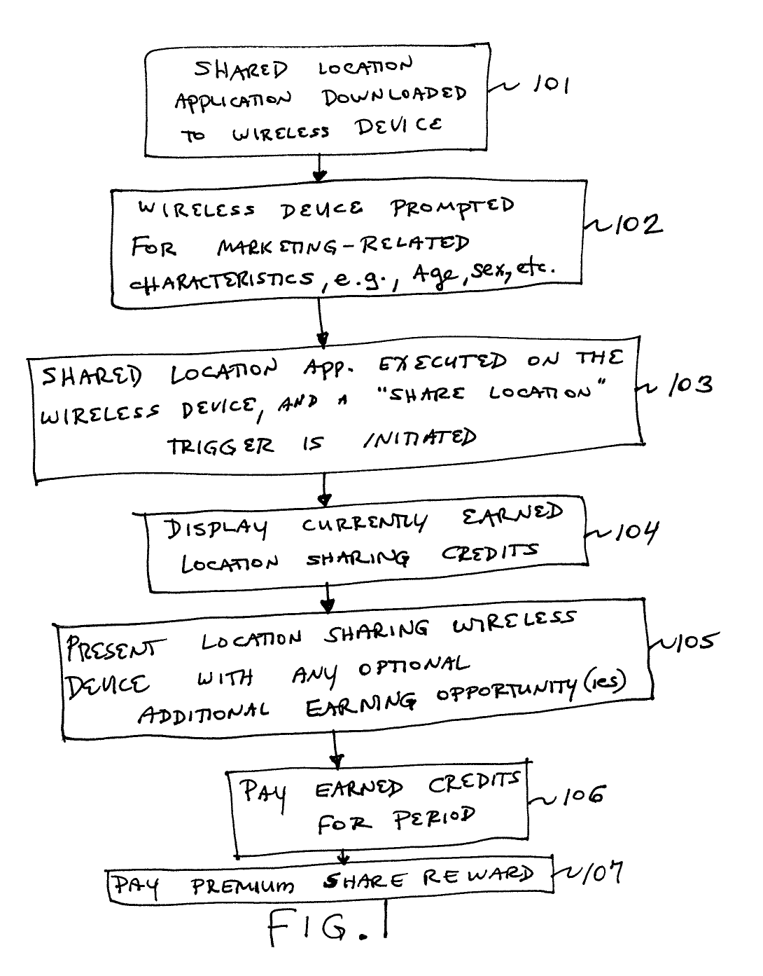

FIG. 1 shows an exemplary method of location sharing, in accordance with the principles of the present invention.

In particular, as shown in step 101 of FIG. 1, a shared location application is downloaded to a given wireless device. This location sharing wireless device is then enabled to “opt-in” and thus ‘sell’ its current location as desired, e.g., when manually triggered or otherwise initiated to do so with respect to a current location of the location sharing wireless device at the time that it ‘opts-in’ when at that location.

In step 102, at setup of the location sharing application on the relevant wireless device, the location sharing wireless device is locally queried preferably just one time for marketing-relevant characteristics, e.g., age, sex, etc., which is then saved in an associated account settings file on the wireless device. This information would also be stored offline in the profile database.

In step 103, the location sharing application is executed on the wireless device, and a suitable ‘share location’ trigger is presented on the display of the wireless device (in the case of a touch-screen device). The location sharing wireless device is then enabled to share its location (plus any authorized personal data) as limited by design. For instance, the location sharing wireless device may ‘opt-in’ and share its current location up to a predetermined number of times per day, e.g., up to ten times per day.

A marketing service-based server maintaining a user account for the location sharing wireless device is credited with a suitable credit, e.g., a cash credit, for each location share (i.e., check-in or opt-in). To ensure that useful location information is shared whenever the ‘share location’ trigger is initiated by the location sharing wireless device, it is preferred that the location of each shared current location be changed, or even significantly changed, from the previously shared location (e.g., must be greater than 30 meters from previous shared location.)

In another embodiment, it may be preferred that not only subsequent shared locations be different, but that a plurality of shared current locations be different from the previous number of shared locations, e.g., different from the previous ten shared locations.

For purposes of the present description, each suitable shared location may be worth, e.g., 10 units.

In step 104, after each location share, the location sharing wireless device preferably displays currently earned credit information for that location sharing device. For instance, the location sharing wireless device may show a graphical representation of associated month-to-date earnings. Additional information may be shown or linked to, e.g., recently redeemed credit information.

In step 105, an additional optional marketing-focused feature may be presented to the location sharing wireless device. For instance, a limited number of times per month, a user may be provided an option to select an additional item to be earned, e.g., a ‘bonus bucks’ optional feature might offer credit for a non-location-based ‘opt-in’ action, e.g., completion and return of a marketing survey. Such a survey preferably may be restricted to frequently using location sharing wireless devices, e.g., location sharing wireless devices that check in at least a predetermined X number of times in the previous week, etc. To help ensure the return of a high percentage of the optional surveys the survey is preferably limited in length (e.g., limited to 5 questions) and/or include, e.g., yes/no and/or multiple choice questions. For purposes of this example, each survey is worth 1.00.

In step 106, the associated account for a given location sharing wireless device is preferably occasionally or periodically paid out, e.g., at the end of each month, in an appropriate form, e.g., a points reward, cash or credit towards partner services, etc. For purposes of this example, if the location sharing wireless device checks in a total of, e.g., 150 accepted times over the preceding logged period of a month (5 times/day for 30 days), and say also completes two marketing surveys, the associated location sharing wireless device earns, e.g., $3.50. If on the other hand the location sharing wireless device checks in even more frequently, say a total of 300 times (10 times/day for 30 days), and completes say four surveys, the wireless device may earn an appropriately higher level, e.g., $5.00.

In step 107, the location sharing wireless application preferably allows for additional bonus or cross-selling/advertising opportunities, or a reward vendor/partner may advertise credits towards other products/services. For instance, a bonus opportunity may be provided every 50,000^{th} share of current location, and offer an associated premium share reward (i.e.: $5.00), coupon, etc.

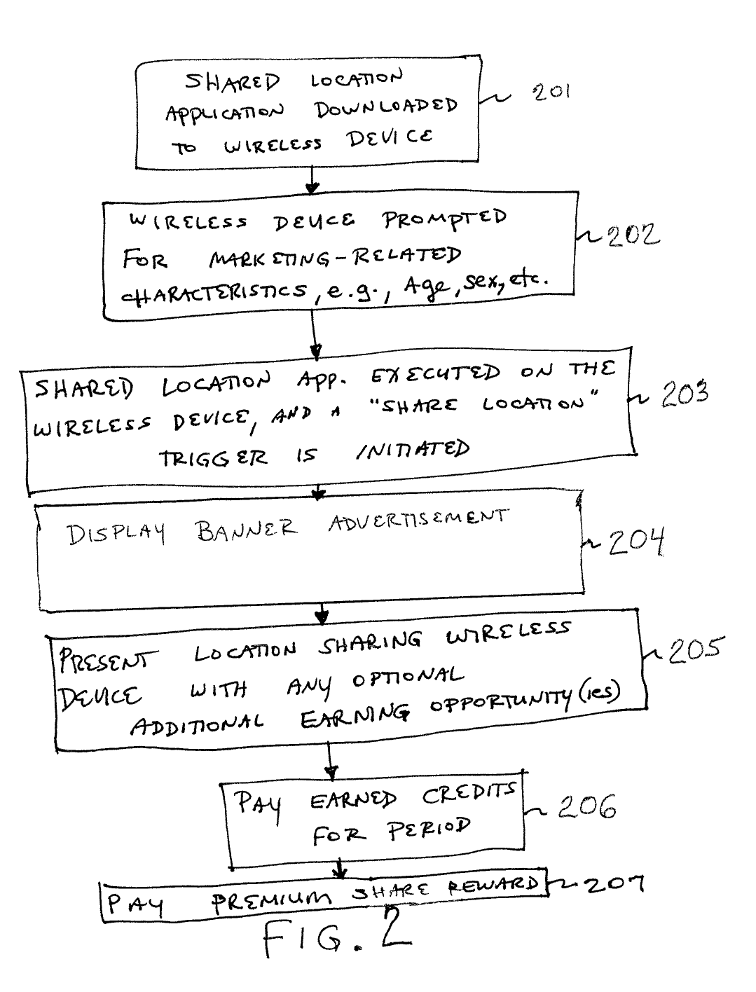

FIG. 2 shows an exemplary embodiment of a location sharing application operable on a wireless device capable of providing a revenue source for a provider of services, in accordance with the principles of the present invention.

In particular, as shown in FIG. 201 of FIG. 2, a location sharing application is downloaded to a wireless device, thus “opting in” that wireless device when it is manually triggered or otherwise instructed to share its current location data.

In step 202, at setup of the location sharing application, the location sharing wireless device is queried one time for marketing-relevant characteristics, e.g., age, sex, etc., which is saved in an associated account settings file.

In step 203, the location sharing application is executed on the wireless device, and a suitable ‘share location’ trigger is initiated by the wireless device. The shared location may be limited to a predetermined number of times per day that it may be used, e.g., up to ten times per day.

A user account for the location sharing wireless device is credited with a suitable credit, e.g., a cash credit, for each location share (i.e., check-in). To ensure that useful location information is shared whenever the ‘share location’ trigger is initiated by the location sharing wireless device, it is preferred that the shared location be changed, or even significantly changed, from the previously shared location (e.g., must be greater than 30 meters from previous shared location.) It is also preferred that a currently shared location be different from the previous number of shared locations, e.g., different from the previous ten shared locations.

For purposes of the present description, each suitable shared location may be worth a given amount, e.g., 10 units.

In an exemplary embodiment, presume for example each sharing of location data is worth ten. Such location information may be stored in a central database. Suitable location information/analytics may include, e.g., age, sex, location, type of location, time of day, historical behaviors, etc. Such location information, together with its analytics, itself becomes an asset to the provider which may be sold (e.g., to mobile marketers) to better enable them to customize mobile advertising campaigns.

In step 204, after each share, the wireless device is sent to a screen showing a graphical representation of their month-to-date earnings.

A banner advertisement may be displayed on such a landing page to provide an additional revenue opportunity for the location-based advertising service provider.

In step 205, a limited times per month, a wireless device including the location sharing application in accordance with the principles of the present invention is provided the option to select a ‘bonus bucks’ option. Surveys are preferably offered only to wireless devices that have checked in at least X number of times in the past week. The wireless device is then taken to a short (e.g., five question) survey of additional marketing research questions, after which the wireless device can proceed.

In an exemplary embodiment, say each survey is worth 1.00.

Generic survey questions pertaining to a specific market segment (e.g., beverages) may be packaged and sold to mobile marketers in that segment. Mobile marketers can buy a weekly survey and customize content for their specific segment needs. A given commercial brand can buy, e.g., a weekly survey opportunity and customize content for their specific brand.

In step 206, at the end of the month, a wireless device is paid out in the form of a points reward, cash or credit towards a partner's services.

In a given exemplary embodiment, a wireless device including a location sharing application checks in a total of, e.g., 150 times in a predefined period (e.g., 5 times/day for 30 days), and completes two surveys. In such a case, the wireless device earns $3.50 credit.

In another example, a wireless device running the location sharing application checks in a total of, e.g., 300 times (10 times/day for 30 days) and completes four surveys. In such a case, the wireless device may earn, e.g., a $5.00 credit.

A reward vendor or partner can pay credits or points or other value to a wireless device in exchange for advertising/branding and marketing stickiness (e.g., PayPal™, airline partner, wireless carrier, etc.) Alternatively, the reward vendor or partner can pay credits or points or other value to a wireless device in exchange for a revenue share of customer data collected to mobile marketers.

In step 207, the location sharing application allows for additional bonus or cross-selling or advertising opportunities. An exemplary cross selling-advertising opportunity exists. For example, an exemplary bonus opportunity may provide every 50,000^{th} share with a premium share reward (e.g., $5.00), or a coupon. As another example, a reward vendor or partner can advertise credits towards other products/services.

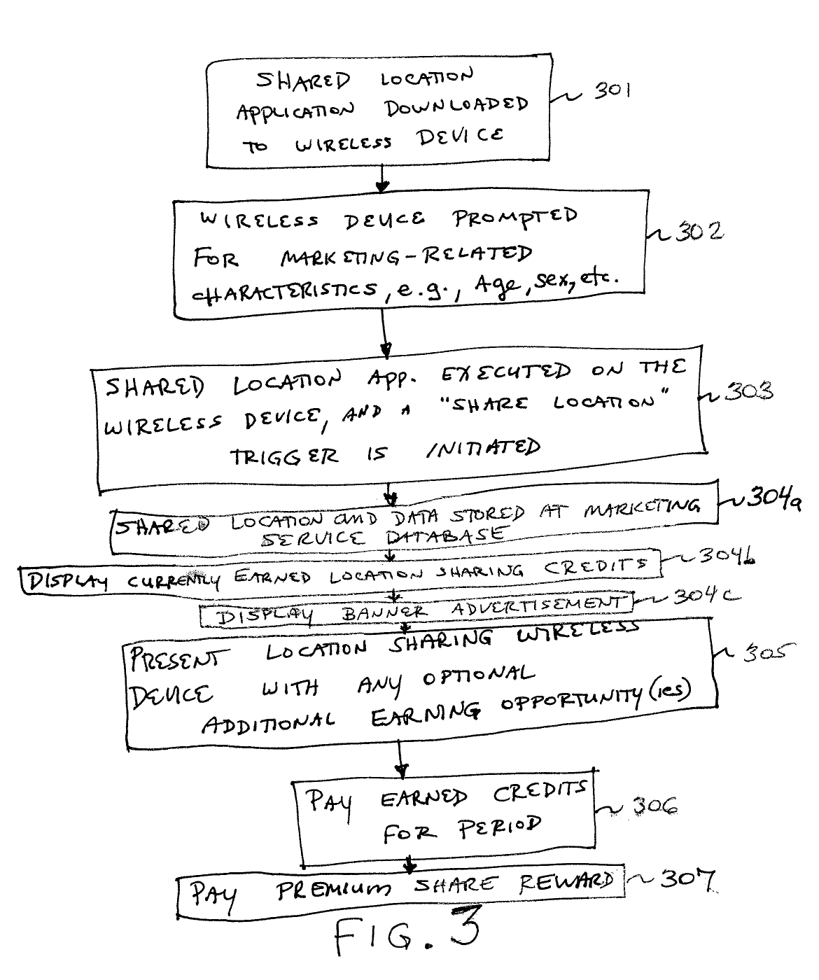

FIG. 3 shows an exemplary embodiment of a carrier channel, in accordance with the principles of the present invention.

In particular, as shown in step 301 of FIG. 3, a wireless device including a location sharing application downloads the relevant location sharing application, thus “opting in” to sharing of location data of the relevant wireless device including the location sharing application.

In step 302, at application set-up, a wireless device including a location sharing application is queried one time for age, sex, etc., which is saved in a suitable account setting.

In step 303, the wireless device including the location sharing application opens the location sharing application by initiating a “share location” button (e.g., up to ten times per day.) The wireless device is credited with cash credit for each location share (i.e.: check-in), as long as the shared location is different from the previous locations provided. For purposes of this example, each share is worth 0.10.

In step 304a, the shared location information including supplied personal data is stored in a central database. Location information/analytics re: age, sex, location, type of location, time of day, historical behaviors, etc. may then be packaged as an asset and sold, e.g., to mobile marketers, to better customize mobile advertising campaigns.

In step 304b, after each share, a wireless device including a location sharing application is sent to a screen showing a graphical representation of their month-to-date earnings.

In step 304c, a banner advertisement may be displayed on this landing page to provide an opportunity for added revenue to the service provider.

In step 305, a limited times per month, a wireless device including a location sharing application is provided the option to select ‘bonus bucks’. Surveys will only be offered to wireless devices that check in at least X number of times in the past week. The wireless device is then taken to a short (e.g., five question) survey of additional marketing research questions, after which they can proceed. As an exemplary embodiment: say each survey is worth 1.00. A generic survey including questions pertaining to a specific market segment (e.g., beverages) is preferably packaged and sold to mobile marketers in that segment.

In another embodiment, e.g., mobile marketers can be offered a weekly survey, and may customize content for their specific segment needs. For instance, a given brand can be offered a weekly survey opportunity, with customized content for their specific brand.

In step 306, at the end of the month, a wireless device including the location sharing application is paid out, e.g., in the form of a points reward, cash or credit towards partner's services.

In one embodiment, say the wireless device including the location sharing application checks in a total of 150 times (5 times/day for 30 days), and completes two surveys. In such a case, the user of the wireless device may have earned, e.g., $3.50 credit towards their wireless phone bill.

In another example, the wireless device including the location sharing application checks in a total of 300 times (10 times/day for 30 days), and completes four surveys. In such a case, the wireless device will have earned, e.g., $5.00 towards the associated wireless phone bill. The wireless carrier may pay credits to an account associated with the wireless device in exchange for advertising or branding, and/or what is known as ‘stickiness’ in marketing. Alternatively, the wireless carrier may pay credits to the relevant account of the wireless device in exchange for a revenue share of customer data collected to mobile marketers.

In step 307, a location sharing application on a wireless device allows for additional bonus or cross-selling or advertising opportunities. An exemplary bonus opportunity may be, e.g., every 50,000^{th} share of relevant location data earns a premium share reward (e.g., provision of a navigation product free for a month, free text messaging for a time period or number of texts, etc.) Cross selling advertisement opportunities may also be offered.

The wireless carrier is enabled to provide credits towards other products or services. For instance, the wireless carrier may offer one month free provision of a navigation service or application to location sharing wireless devices. Alternatively, the wireless carrier can provide one month free of the navigation product to navigation product users' wireless devices if those navigation product wireless devices users cross over to also use the location sharing application product. Alternatively yet, the wireless carrier can provide one month free of cable service and/or data services to a home associated with a wireless device (or otherwise designated) as a reward for completion of a survey of high value (e.g., upon completion of a fifth survey of high value data.) Enterprise employees can ‘earn’ credits towards their phone bill with the relevant wireless carrier. Or, the wireless carrier may generate revenue by providing ‘top-earner’ reports to enterprises. Also, a contest may be established to permit a ‘top-earner’ to win additional prize/coupon, etc.

While the invention has been described with reference to the exemplary embodiments thereof, those skilled in the art will be able to make various modifications to the described embodiments of the invention without departing from the true spirit and scope of the invention.

What is claimed is:

1. A method of tracking location of a wireless device, comprising:
registering a wireless device including a location sharing application;
receiving a user-triggered report of current location;
accepting said user-triggered report of current location by verifying that said relevant location sharing wireless device has moved; and
crediting said location sharing wireless device with value;
whereby privacy is ensured by enabling disclosure of current location only if, when and where said location sharing wireless device initiates such disclosure.

2. The method of tracking location of a wireless device according to claim 1, further comprising:
associating said user-triggered report of current location with profile data;
whereby privacy is ensured by enabling disclosure of said profile data associated with said current location only if, when and where said location sharing wireless device initiates such disclosure.

3. The method of tracking location of a wireless device according to claim 1, further comprising:
receiving said user-triggered report of current location together with profile data from said location sharing wireless device;
whereby privacy is ensured by enabling disclosure of said profile data with said current location only if, when and where said location sharing wireless device initiates such disclosure.

4. The method of tracking location of a wireless device according to claim 1, wherein said verification that said location sharing wireless device has moved comprises:
verifying that said location sharing wireless device has moved since a last received user-triggered report of current location for said location sharing wireless device.

5. The method of tracking location of a wireless device according to claim 1, wherein said verification that said location sharing wireless device has moved comprises:
verifying that said location sharing wireless device has moved to a location different than each of a plurality of last received user-triggered reports of current location for said location sharing wireless device.

6. The method of tracking location of a wireless device according to claim 5, wherein:
said plurality of last received user-triggered reports of current location is at least ten.

7. The method of tracking location of a wireless device according to claim 1, wherein said credited value comprises:
a credit towards a phone bill.

8. The method of tracking location of a wireless device according to claim 1, wherein said credited value comprises:
a coupon for a future retail purchase.

9. The method of tracking location of a wireless device according to claim 1, wherein said credited value comprises:
a credit towards a fee-based application.

10. The method of tracking location of a wireless device according to claim 1, wherein said credited value comprises:
a credit towards provision of a navigation service.

11. A method of providing location of a wireless device, comprising:
executing a location sharing application on a wireless device;
manually triggering a first report of a first current location of said location sharing wireless device sent to a network server;
changing location of said wireless device;
manually triggering a second report of a second current location of said location sharing wireless device sent to said network server;
receiving a value credit upon verification that said first current location is significantly different from said second current location;
whereby privacy is ensured by enabling disclosure of current location only if, when and where said location sharing wireless device initiates such disclosure.

12. The method of providing location of a wireless device according to claim 11, further comprising:
pre-registering profile data to be associated with said user-triggered first report of current location;
whereby privacy is ensured by enabling disclosure of said profile data associated with current location only if, when and where said location sharing wireless device initiates such disclosure.

13. The method of providing location of a wireless device according to claim 11, further comprising:
sending profile data with said user-triggered first report of current location to said network server;
whereby privacy is ensured by enabling disclosure of said profile data associated with current location only if, when and where said location sharing wireless device initiates such disclosure.

14. The method of providing location of a wireless device according to claim 11, wherein said value credit comprises:
a credit towards a phone bill.

15. The method of providing location of a wireless device according to claim 11, wherein said value credit comprises:
a coupon for a future retail purchase.

16. The method of providing location of a wireless device according to claim 11, wherein said value credit comprises:
a credit towards a fee-based application.

17. The method of tracking location of a wireless device according to claim 11, wherein said value credit comprises:
a credit towards provision of a navigation service.
